(19) United States
(12) Patent Application Publication
(10) Pub. No.: US 2014/0074638 A1
(43) Pub. Date: Mar. 13, 2014

(54) CONSUMER SELF-AUTHORIZATION FOR ELECTRONIC RECORDS

(71) Applicant: Shahid N. Shah, Silver Spring, MD (US)

(72) Inventor: Shahid N. Shah, Silver Spring, MD (US)

(73) Assignee: NETSPECTIVE COMMUNICATIONS LLC, Silver Spring, MD (US)

(21) Appl. No.: 13/607,997

(22) Filed: Sep. 10, 2012

(51) Int. Cl. G06F 21/00; G06Q 30/06

(52) U.S. Cl. 705/26.1; 726/4

(57) ABSTRACT

A system and method for authorizing access to a third party at least in part for medical records. The system includes at least one server that includes or is coupled to at least one central repository. The at least one central repository stores multiple patient files. A patient is registered with the at least one central repository using a sign in scheme and allowed to store the medical records associated with the patient after signing in through the sign in scheme. The system further includes a device for authorizing access to the third party for the medical records at least in part. The device includes a second repository storing a set of rules dictating access rights and levels for the third party and an access module that processes authorization of the third party for access of the medical records.

### BACKGROUND

1. Technical Field

The embodiments herein generally relate to management of electronic records, and, more particularly, to storage, access and authorization of electronic records for access over a network platform.

2. Description of the Related Art

Generally, several types of services such as financial services, healthcare services or information services or others, and associated parameters, attributes and responses related to the services are documented by entities such as physicians, doctors, hospitals or other service providers, analysts, specialists, and others dealing in information management. At times, information holders or owners such as patients may also document their information or data. With the advent of new technologies, such types of documented information can be stored electronically which is generally referred to as electronic records.

Electronic records are user or owner specific and are generally kept as confidential by the owner of the information or the records. In modern days, these records can be deposited and secured in a central repository that is connected over a networked platform such as through an internet that can be accessible by the owner easily.

In certain conditions, a third party other than the patient such as a general consumer of the information or records may be interested in the electronic records and may want to access them. However, as per the conditions prescribed by several authorities and standards such as the Health Insurance Portability and Accountability Act (HIPPA) meant for health related information and several others, it is imperative and important to gain authorization from an owner for accessing his electronic records. The process of authorization can be fairly simple if the records are limited. A third party or a consumer may directly approach the owner for authorization. However, as the data contained within the records increase to a large extent, the task of identifying relevant data and gaining access and authorization becomes complex and difficult. Also, it is justified to set up a system to pay the owners financially or otherwise, in return of the authorization for the access.

Therefore, in light of the above, there is a need of a system and a method for electronic records management and storage, and for providing authorization to a third party by an owner or the system on behalf of the owner to access the electronic records. Also, the system should be capable of facilitating a marketplace where the owners can sell or license out their electronic records and generate revenue in return.

### SUMMARY

The embodiments herein provide a system for storing and creating medical records, and authorizing access to a third party, at least in part, for the medical records. The system includes at least one server that includes or is coupled to at least one central repository. The at least one central repository stores multiple patient files, such that each patient file is associated with a patient and contains patient data. The patient is registered with the at least one central repository via a sign in scheme and allowed to store the medical records associated with the patient after signing in through the sign in scheme. The system further includes a communication network such that the system is connected over the communication network, and the network further facilitates communication between the patient and the third party. The system further includes a device for authorizing access to the third party for the medical records at least in part. The device includes a second repository storing a set of rules dictating access rights and levels for the third party based on information associated with the third party. The device further includes an access module that processes authorization of the third party for access of the medical records, at least in part. The device further includes a processing component that creates the medical records, at least in part, based on the authorization by the access module.

The embodiments herein provide a system for storing and creating electronic records and for authorizing access to a consumer, at least in part, for the electronic records by an owner of the electronic records. The system includes at least one server that includes or is coupled to at least one central repository. The at least one central repository stores multiple files. Each file is associated with an owner of the electronic records and contains data specific to the owner. The owner is registered with the at least one central repository through a sign in scheme and allowed to store the electronic records associated with the owner after signing in through the sign in scheme. The system includes a communication network such that the system is connected over the communication network and the network facilitates communication between the owner and the consumer. The system further includes a device for authorizing access to the consumer for the electronic records at least in part. The device includes a second repository storing a set of rules dictating access rights and levels for the consumer based on information associated with the consumer. The device also includes an access module that processes authorization of the consumer for access of the electronic records, at least in part. The device further includes a processing component that creates the electronic records, at least in part, based on the authorization by the access module.

The embodiments herein provide a method for storing and creating medical records, and authorizing access to a third party at least in part for the medical records. The method includes receiving a registration request with a central repository through a sign in platform from a patient. The sign in scheme can be accessed through a social networking platform, in an embodiment. The method further includes receiving information from the patient including such as: personal details of the patient and details related to the patient indicative at least of the medical records associated with the patient for storage within the central repository. The method further includes defining access rules dictating access rights for the third party desiring an authorization for access of the medical records, at least in part, based on the information associated with the third party and the information received from the patient.

The embodiments herein provide a program storage device readable by a computer, and including a program of instructions executable by the computer to perform a method of storing and creating medical records, and authorizing access to a third party at least in part for the medical records. The method includes receiving a registration request with a central repository through a sign in scheme from a patient. The sign in scheme being accessed through a social networking platform. The method further includes receiving information from the patient including such as: personal details of the patient and details related to the patient indicative at least of the medical records associated with the patient for storage within the central repository. The method further includes defining access rules dictating access rights for the third party desiring an authorization for access of the medical records, at least in part, based on the information associated with the third party and the information received from the patient.

### BRIEF DESCRIPTION OF THE FIGURES

The embodiments herein will be better understood from the following detailed description with reference to the drawings, in which:

FIG. 1 illustrates generally, but not by way of limitation, among other things, an example of an environment or architecture in which various embodiments herein may operate;

FIG. 2 illustrates generally, but not by way of limitation, among other things, a specific example of an environment or architecture in which at least some embodiments herein may operate;

FIG. 3 illustrates a system for storing and creating medical records, and authorizing access to the third party, at least in part, for the medical records according to the embodiments herein;

FIG. 4 illustrates a network of several parties representing as similar to the third party that are connected with a patient according to the embodiments herein;

FIG. 5 illustrates generally, but not by way of limitation, an example of an interface providing a capability to the third party such as to access the server for requesting the authorization to access or create the medical records, at least in part, stored at the server according to the embodiments herein;

FIG. 6 is a flowchart illustrating a method for sharing the medical records by the patients with the server for the purpose of such as authorizing the third party to access the medical records according to the embodiments herein;

FIG. 7 is a flowchart illustrating a method of granting access or authorizing the third party for the medical records, at least in part, by the server or the patient according to the embodiments herein; and

FIG. 8 illustrates a representative hardware environment for practicing various embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In this document, the terms “a” or “an” are used, as is common in patent documents, to include one or more than one. In this document, the term “or” is used to refer to a “nonexclusive or”, unless otherwise indicated.

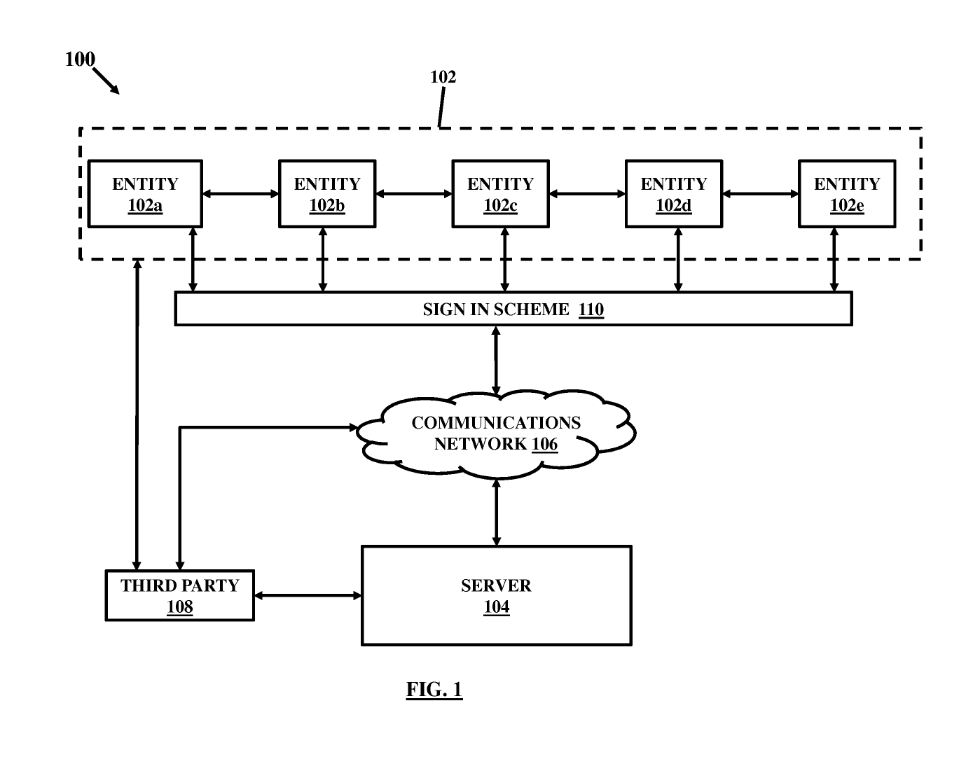

FIG. 1 illustrates generally, but not by way of limitation, among other things, an example of an environment or architecture 100 in which various embodiments herein may operate. As illustrated in FIG. 1, the environment 100 constitutes a plurality of entities 102a, 102b, 102c, 102d, and 102e, together referred to as 102, communicatively in connection with a server 104 over a network 106.

In embodiments, the entities 102 may include patients, financial professionals, experts of various domains, researchers, scholars, students, or any other person who maintains records related to specific tasks. The entities 102, as described herein, generally maintain records more specifically in the form of electronic forms referred to as electronic records. The entities 102 may be connected communicatively with one another and also with the server 104.

The server 104 is configured as a central repository or a database for managing and storing the electronic records of the entities 102. In accordance with various embodiments, the server 104 stores the electronic records that are submitted by the entities 102. These records may include such as financial records, medical or health records, scientific records, literary work, intellectual property or copyrighted material, personal records, and the like, without limitations.

As shown, the architecture 100 also includes a third party 108 which may be communicatively connected with the entities 102 directly or indirectly through the server 104 over the network 106. The third party 108 may serve as a customer who may desire to access the electronic records, at least in part. In embodiments, the third party 108 may include patients, financial service providers such as insurance companies, healthcare professionals or healthcare service providers, and the like.

The entities 102 can be communicatively connected with the server 104 by such as registering with the server 104. The entities 102 can register, in an embodiment, through a sign in scheme 110. The sign in scheme 110 can facilitate as a networking platform or portal for configuring communication among the entities 102 and also between the entities 102 and the server 104. Also, the sign in scheme 110 can communicatively connect the entities 102 and the server 104 with the third party 108. In an embodiment, the sign in scheme 110 can be established with the use of a networked portal. In an embodiment, the sign in scheme 110 can be established with the use of such as a social networking platform.

The network 106 can be a wireless or a wired network. The network 106 can operate as a communications network configuring communication among the entities 102, the server 104, and the third party 108. In an embodiment, the network 106 can be an internet. The entities 102, the server 104, and the third party 108 can be distributed over a wide area and can connect remotely among themselves over the network 106.

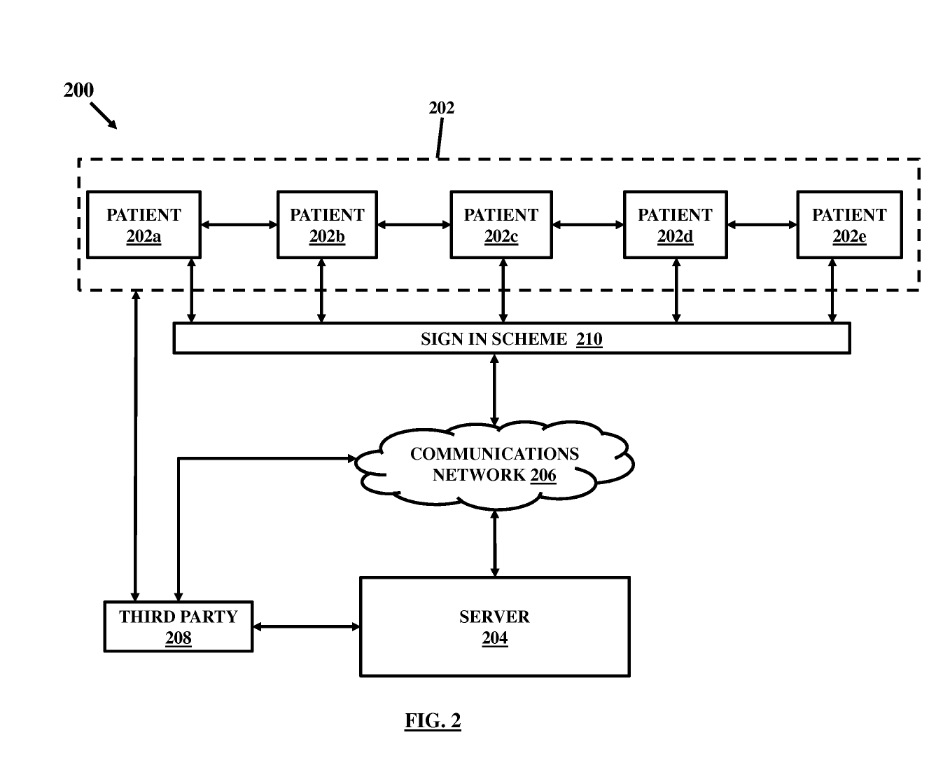

FIG. 2, with reference to FIG. 1, illustrates generally, but not by way of limitation, among other things, a specific example of an environment or architecture 200 in which at least some embodiments of the present invention may operate. As illustrated in FIG. 2, the environment constitutes a plurality of patients 202a, 202b, 202c, 202d, and 202e (together referred to as 202 hereafter) communicatively in connection with a server 204 over a network 206. The patients 202 can be communicatively connected with the server 204 by such as registering with the server 204. The patients 202 can register, in an embodiment, through a sign in scheme 210 which is similar to the sign in scheme 110 as described with respect to FIG. 1.

As shown, the architecture 200 also includes a third party 208 which may be communicatively connected with the patients 202 directly or indirectly through the server 204 over the network 206. The third party 208 may serve as a customer who may desire to access such as medical records, at least in part. In embodiments, the third party 208 may include patients, healthcare professionals or healthcare service providers, and the like. It should be appreciated that FIG. 2 illustrates an exemplary environment applicable for creating or storing or managing or authorizing access for medical records in a typical medical or healthcare environment, however the embodiment herein are equally applicable to other environments such as those generically recited and discussed without limitations in conjunction with FIG. 1.

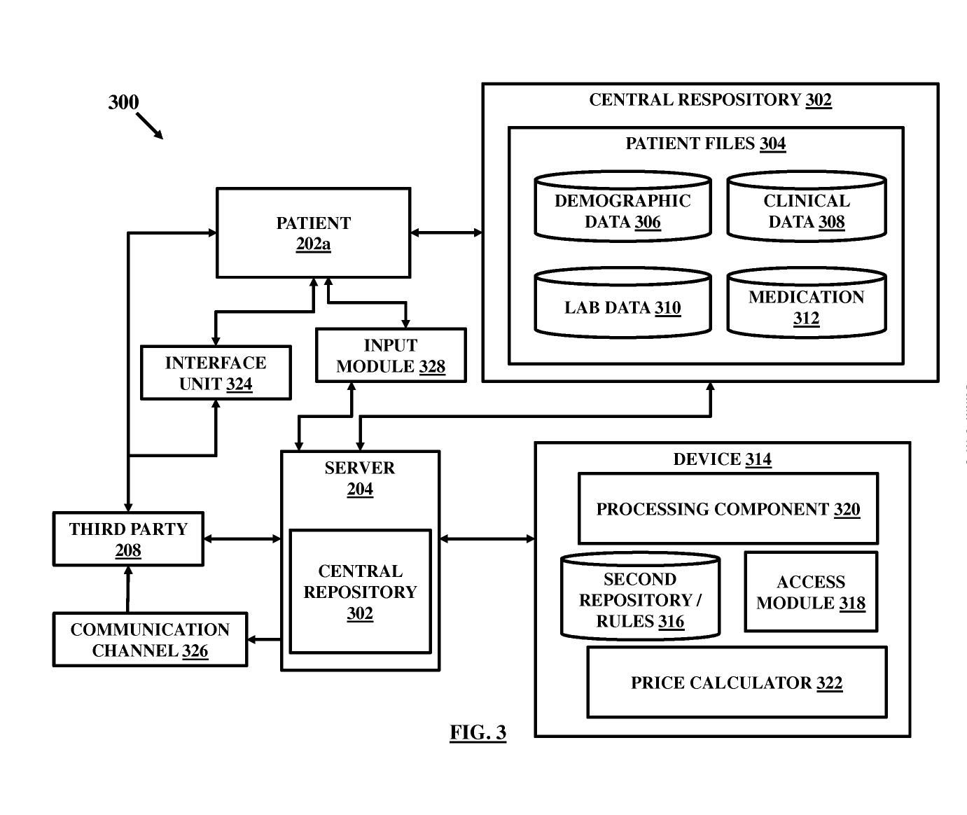

Referring now to FIGS. 3-8, the embodiments herein are discussed in conjunction with the environment 200 discussed in FIG. 2, as an exemplary embodiment.

FIG. 3, with reference to FIGS. 1 through 2, illustrates a system 300 for storing and creating medical records, and authorizing access to the third party 208, at least in part, for the medical records. As shown, the system 300 includes at least one server similar to the server 204. The server 204 includes or is coupled to at least one central repository 302. The at least one central repository 302 stores multiple patient files 304. Each patient file is associated with a patient such as 202a and contains patient data. The patient 202a is registered with the at least one central repository 302 via the sign in 210 scheme and allowed to store the medical records associated with the patient 202a after signing in through the sign in scheme 210. In an embodiment, the information submitted and stored by a patient 202a in the server 204 can be collated together to define a sub-database specific for the patient 202a that can be referred to as a patient file. Similarly, several patients storing information for various patients constitute what is termed here as patient files 304. The patient files 304 may include patient information or patient data of a variety of types. For example, in an embodiment, the information or data may include at least one of demographic data 306, clinical data 308, lab data 310, medication related data 312, and the like without limitations. In an embodiment, the patient data may include the medical history of the patient 202a such that the patient file may define the medical history of the patient 202a. In an embodiment, critical patient information is stored in the patient files such that the patient file defines critical patient information for the patient 202a.

As discussed in conjunction with FIGS. 1 and 2, the patient 202a can store the data or patient files in the server 204 upon registering with the server 204 through such as the sign in scheme 210 enabled through such as an internet based platform. The internet based platform can be a social networking platform, in an embodiment. In an embodiment, the patient 202a can access the server 204 for registration through his/her personal login details configured for accessing such as his/her social networking platform or internet based emailing platforms. In another embodiment, the patient 202a, upon signing in through the sign in scheme 210 may be directed to an altogether separate interface linked to such as his/her social networking platform. The interface, in such cases, may generate fresh credentials for accessing the server 204 through such as his/her social networking platforms.

In an embodiment, information indicative of a patient interest in selling or authorizing access for the medical records, at least in part, is viewable publicly to the third party 208 upon registration of the patient 202a with the central repository 302.

The system 300 further includes the communication network 206 (shown in FIG. 2) such that the system 300 is connected over the communication network 206. The network 206 further facilitates communication between the patient 202a and the third party 208. In an embodiment, the third party 208 can access the server 204 upon registration in a manner similar to that described above with respect to the patients 202. In other embodiments, several other ways of access may also be possible such as gaining a subscription for a dedicated interface that links the third party 208 to the server 204 and its data stored therein. However, access to the data or information stored on the server 204 such as the patient files 304, either in part or in entirety, is conditional subject to authorization from the patient 202a associated with the respective patient files 304 and may be accessed only upon successful authorization and payment for the access.

The system 300 further includes a device 314 for authorizing access to the third party 208 for the medical records, at least in part. The device 314 includes a second repository 316 that stores a set of rules dictating access rights and levels for the third party 208 based on information associated with the third party 208. In an embodiment, the set of rules are defined by the patient 202a based on such as a role of the third party 208, scope of authorization, nature of access, nature or purpose of usage of the medical records, payments associated in return of the access, type of information such as demographic, lab data, medication related, and the like. In an embodiment, specific types of information may be defined by unique identifiers such as for example demographic information of the patient 202a may be defined by a first identifier, clinical information of the patient 202a may be defined by a second identifier, lab information of the patient 202a may be defined by a third identifier, and medication related information may be defined by a fourth identifier. The set of rules as defined by the patients 202a may be associated with specific identifiers so as to cumulatively define rules based on the nature of the information. Thus, the set of rules may vary as the nature of information varies. Similarly, the set of rules may also define payment options and payment requirements which may also be associated in conjunction with the identifiers for the specific information. Therefore, payment requirements for example for the demographic information may be different from the payment requirements of the clinical information. In an embodiment, the patient 202a may also place strong restrictions for accessing more complicated, important and critical information such as medication related information as compared to relatively less critical information such as demographic information. Accordingly, the third party 208 may be required to justify its access such as by producing valid documents highlighting importance and genuineness of the access. Also, in such cases, the payment requirements may be higher relatively as defined by the set of rules in association with a respective identifier. In general, the set of rules are defined to govern access of the third party 208 and validate the access by the patient 202a.

The device 314 further includes an access module 318 that processes authorization of the third party 208 for access of the medical records, at least in part. In an embodiment, the authorization is processed by using an output generated by the access module 318 based on the set of rules, information received from the third party 208 defining nature of the third party 208, purpose of the access, and scope of access, and the like. The access module 318 receives detailed quantitative and/or qualitative information from the third party 208 before providing authorization. The access module 318 is coupled to the second central repository 316 and is configured to accesses the set of rules stored therein and map the received information from the third party 208 onto the set of rules. Upon mapping, the access module generates an output that decides a grant or denial of authorization for the medical records specific to the patient 202a.

The device 314 further includes a processing component 320 that creates or extracts the medical records, at least in part, based on the authorization by the access module 318. The processing component 320 receives an input from the access module 318 and accordingly configures and issues a command to extract the requested medical records and email them to the third party 208 or save at a defined location for access by the third party 208, or give direct access rights to the third party 208 or sends a print command for issuing hard copies thereof.

In an embodiment, the device 314 also includes a price calculator 322 that is configured to associate a numerical value to the request of the third party 208 for gaining authorization to the medical records, at least in part, as requested by the third party 208. The numerical value defines a billable amount to be paid by the third party 208 in return of the authorization grant for the medical records, at least in part. In an embodiment, price standards can be defined by the patient 202a in association with specific types of the information that are defined by their respective identifiers. The price standards can be stored as a part of the set of rules or can also be stored and considered separately. The price calculator 322 can associate the price standards such as based on the set of rules with the information received from the third party 208 specifying such as nature and role of the third party 208, purpose of the access, and scope of the access, and with the type of information such as defined by the identifiers. For example, a specific combination of the information received from the third party 208 and the demographic information for a specific role of the third party 208 and for a specific purpose and scope of access may yield a price value different from another combination for the same third party 208 but with different purpose and scope of the access and for different information such as lab data or clinical information. In an embodiment, the price calculator 322 may operate based on certain defined algorithms that operate hardware elements of the price calculator 322 to function for calculation purposes resulting in an output in the form of a numerical value that can be associated with the request for authorization as its billable charge. The concept as defined by the price calculator 322 in association with other concepts of the invention allows the patient 202a and other patients such as 202 to be paid for their medical records such as by the third party 208 who wishes to gain or gains access for them or buys or wishes to buy or gains license or wishes to gain license, at least in part. The pay as you buy or pay as you access concept facilitate to set up a marketplace enabled through the network 206 such as through the internet for open selling, purchasing and licensing of medical records.

In an embodiment, the system 300 may include an interface unit 324 for providing an interface to the patient 202a and the third party 208 to respectively update the patient's medical records by the patient 202a and view or extract the medical records by the third party 208 as authorized by the patient 202a, at least in part.

The system 300 may include a communication channel 326 allowing transfer of the medical records through at least one of a wired and wireless transmission technique to a destination identified by the third party 208, upon successful authorization of the access by the patient 202a and payment of a billable amount equivalent to obtain the access right of the medical records, at least in part, as specified by the patient 202.

In an embodiment, the system 300 further includes a patient input module 328 to receive an input manually from the patient 202a regarding authorization access in terms of binary values and costs associated with the authorization access. The binary values may represent as YES or NO representing grant or denial of the access respectively to the third party 208 for a specific request. In an embodiment, the set of rules can be used in association with the input received manually from the patient 202a for providing access to the third party 208. In accordance with various scenarios, the patient 202a can be allowed to alternatively select one of the below two options for authorization:
The first option may include an automated way of access authorization for the medical records, at least in part, based on the set of rules stored in the second repository 316.
The second option includes a manual way of access authorization for the medical records, at least in part, based on the input received by the patient 202a manually through the input module 328.

In an embodiment, the third party 208 can also be communicatively connected to the patient 202a through such as the social networking platform or any other networked platform through the sign in scheme 210.

In an embodiment, the server 204 can be maintained by a service provider of a social networking service such that the server 204 is one of several repositories maintained by the provider of the social networking service through the social networking platform.

In accordance with an embodiment, the system 300 is described with respect to medical records. However, it must be appreciated that the system 300 can be employed in other scenarios also within the scope of the embodiments herein. For example, in an embodiment, the system 300 can be used for storing and creating electronic records including but limited to medical records, financial records, scientific literature, art and literature, and the like and for authorizing access to a consumer (similar to the third party 208) at least in part for the electronic records by an owner/user similar to the patient 202a of the electronic records. The system 300 includes the at least one server 204 that includes or is coupled to the at least one central repository 302. The at least one central repository 302 stores multiple files similar to 304. Each file is associated with an owner of the electronic records and contain data specific to the owner. The owner is registered with the at least one central repository 302 through the sign in scheme 210 and allowed to store the electronic records associated with the owner after signing in through the sign in scheme 210.

The system 300 includes the communication network 206 such that the system 300 is connected over the communication network 206 and the network 206 facilitates communication between the owner and the consumer. The system 300 further includes the device 314 for authorizing access to the consumer for the electronic records at least in part. The device 314 includes the second repository 316 storing the set of rules dictating access rights and levels for the consumer based on information associated with the consumer. The device 314 also includes the access module 318 that processes authorization of the consumer for access of the electronic records, at least in part. The device 314 further includes the processing component 320 that creates the electronic records, at least in part, based on the authorization by the access module 318.

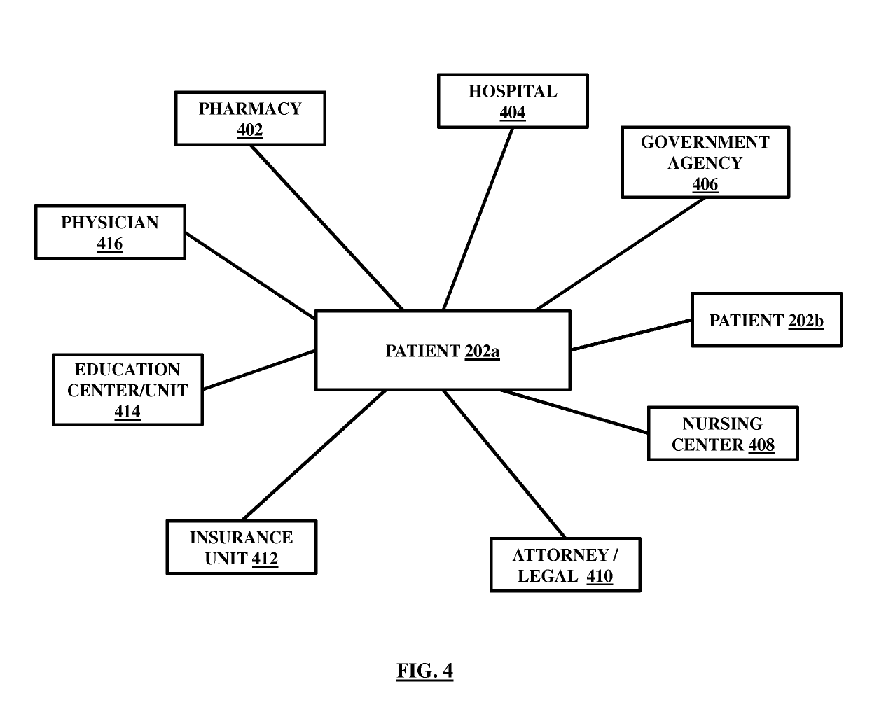

FIG. 4, with reference to FIGS. 1 through 3, illustrates a network of several parties representing as similar to the third party 208 and hereafter referred to as third parties, in combination, that are connected with the patient 202a as discussed above. In accordance with some embodiments, the third party 208, as shown, can be a pharmacy 402, a hospital 404, government agency 406, another patient 202b different from the patient 202a, nursing center 408, attorney or a legal department 410, insurance unit 412, education center 414, physician 416, and the like, without limitations. As understood from the general meaning of various third parties shown in FIG. 4, the roles and purposes of the third parties may vary.

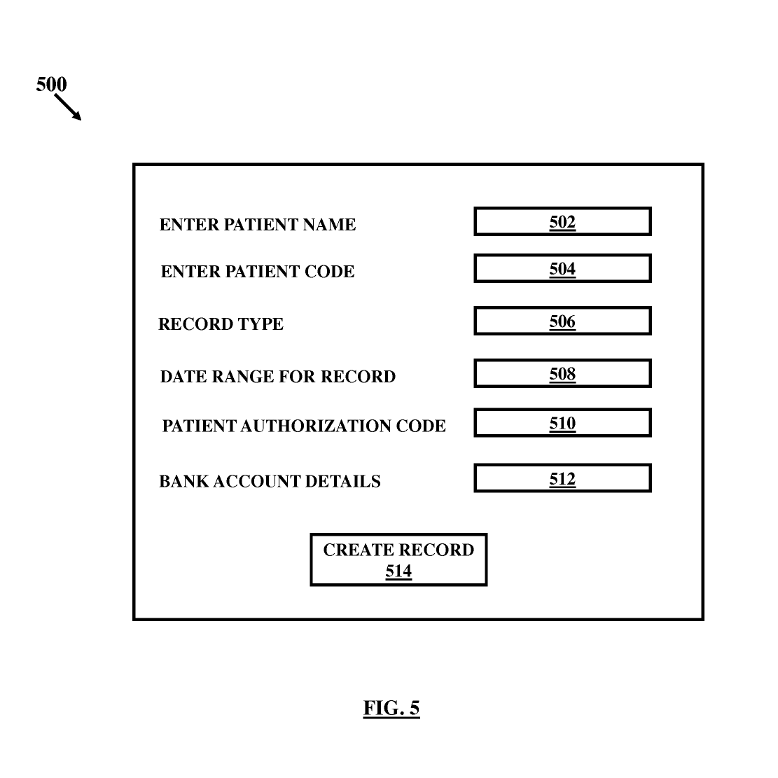

FIG. 5, with reference to FIGS. 1 through 4, illustrates generally, but not by way of limitation, an example of an interface 500 providing a capability to the third party 208 such as to access the server 204 for requesting the authorization to access or create the medical records, at least in part, stored at the server 204.

The interface 500, as shown in FIG. 5, can be accessed such as through a credential provided to the third party 208 and including a login identifier and a unique personal password. The interface 500 can include such as a tab 502 for entering patient name whose medical records are required to be accessed. The interface 500 can also include such as a tab 504 for entering a patient code specific for the patient 202a whose medical records are required to be accessed. The third party 208 can also filter the requested access by providing details of the nature of information requested such as demographic, clinical, medication, lab report and the like through another record type tab 506 facilitated on the interface 500. The interface 500 can also include such as a tab 508 for entering date limitations for the records to be accessed. It must be appreciated that some or all of the above tabs may be replaced by other tabs, in accordance with other embodiments, as per requirements without limiting the scope of the invention. For example, instead of the tabs for patient name and patient code, a searchable interface may be provided that can be configured to search for patients relevant for a specific type of medical information. The searchable interface can automatically search and generate names and codes of relevant patients which can be shortlisted by the third party 208. Similarly, several other modifications in the tabs and the interface 500 can be made within the scope of the embodiments herein.

In addition, the tabs as discussed above, and the interface 500 may include one or several tabs to identify banking, financial, and payment related details of the third party such as to launch a financial transaction. As an example shown in FIG. 5, the interface 500 includes a tab 512 referred to as bank account details which may be used to provide bank details or other financial details such as credit card number, debit card number, bank account number, and bank name and branch, and the like. The grant of authorization may also depend on the verification of the bank account details along with several other details. The verification can be done by linking the interface 500 with the respective bank through a secured internet portal.

Before requesting for the authorization, the third party 208 is required to be authorized for the access by the respective patient 202a who holds rights of the requested medical records. The third party 208 can either directly and physically and separately connect with the patient 202a or through the interface 500 so as to get authorization. Upon patient authorization, the third party 208 receives a patient authorization code which may be required to be submitted through the interface 500 along with other details such as through another tab 510 meant for patient authorization code. It must be appreciated that the patient authorization can be completely automated, in an embodiment, such that the request for access can be authorized or denied automatically based on the set of rules stored in the second repository 316 and based on the information received from the third party 208 such as during submitting of the information through the interface 500. The authorization can also be almost simultaneously processed during the submission of the details through the interface 500. If the authorization is granted, a button 514 meant for such as to create the medical records is made operable or visible to the third party 208 on the interface 500 for clicking resulting in extraction of the medical records on a local disk or space, or emailing of the medical records on a personal email inbox, or retrieval in any other possible manner, upon clicking.

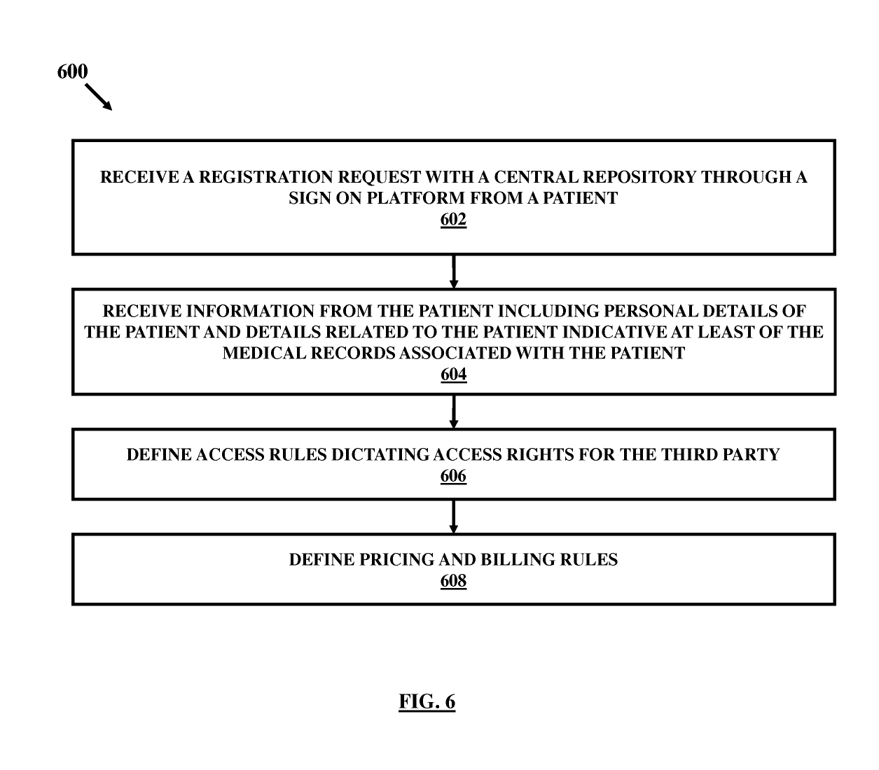

FIG. 6, with reference to FIGS. 1 through 5, illustrates a method 600 for sharing the medical records by the patients 202 with the server 204 for the purpose of such as authorizing the third party 208 to access the medical records. At step 602, the method includes receiving a registration request with the central repository 302 through the sign in scheme 210 from the patient 202a. At step 604, the method 600 includes receiving information from the patient 202a such as including personal details of the patient 202a and details related to the patient 202a indicative at least of the medical records associated with the patient 202a. The details related to the patient 202a indicative of the medical records may be the medical records associated with the patient 202a which are submitted by the patient 202a for storage on the server 204 upon registration and further sharing with others such as the third party 208 later on as per the conditions specified by the patient 202a such as through the set of rules. At step 606, the method 600 includes defining access rules dictating access rights for the third party 208. In an embodiment, the access rules can form a part of the entire set of rules as defined by the patient 202a along with other information such as payment related rules. At step 608, the method 600 includes defining pricing and billing rules or payment related rules. In an embodiment, the access rules and the pricing and billing rules together make up the set of rules. However, in some embodiments, the set of rules may include some more rules governing the access, authorization, and payment and data sharing and management other than the access and pricing and billing rules as discussed above.

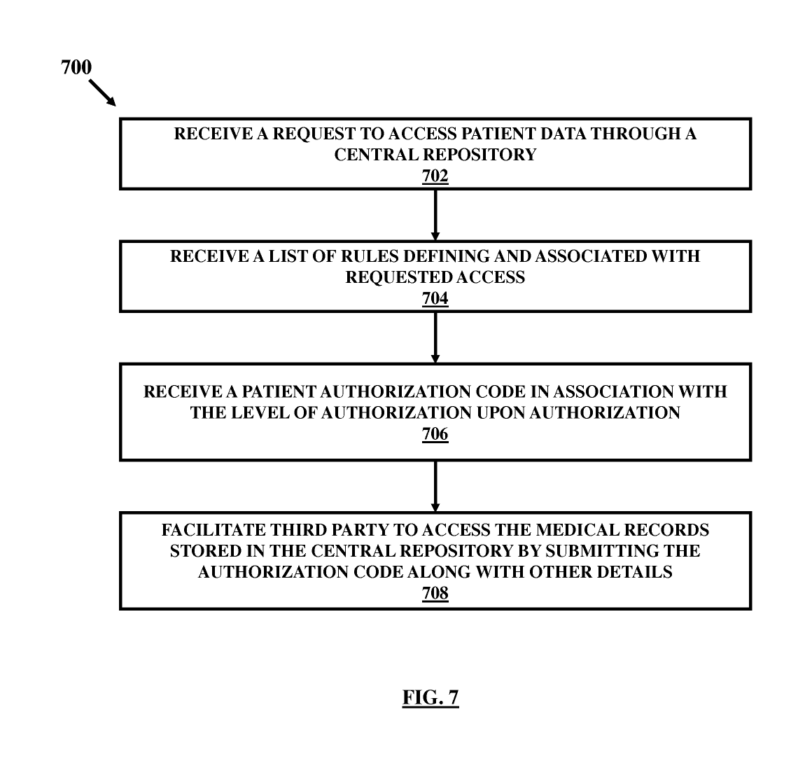

FIG. 7, with reference to FIGS. 1 through 6, illustrates a method 700 of granting access or authorizing the third party 208 for the medical records, at least in part, by the server 204 or the patient 202a. At step 702, the method includes receiving the request from the third party 208 to access the patient data or the medical records associated with the patient 202a through the central repository 302 of the server 204. At step 704, the method 600 includes receiving a list of rules defining and associated with the requested access. The list of rules is accessed from the second central repository 316 configured to store the set of rules. In an embodiment, the list of rules is a subset of the set of rules and including those rules pertaining to the specific request out of the entire set of rules. In an embodiment, the list of rules can be same as the set of rules. At step 706, the method 700 includes receiving the patient authorization code in association with the level of authorization upon authorization by the patient 202a. In an embodiment, the request first may be redirected to the patient 202a for authorization. In another embodiment, the request may be automatically processed for authorization based on the set of rules defined by the patient 202a. If the authorization results in the grant of the access, the authorization code is generated which is used by the server 204 for allocating rights to access the medical records. On the contrary, if the access is denied, the authorization code is not generated, and the third party 208 is denied or blocked for access. At step 708, in case the authorization is made, the method 700 includes facilitating the third party 208 to access the medical records stored in the central repository 302 by submitting the authorization code along with other details. Before final authorization, the third party 208 may be required to clear payments for the access of the medical records, at least in part.

In an embodiment, the method 700 includes updating the set of rules periodically by the patient 202a, and terminating the access of an already authorized access upon not meeting requirements prescribed by a new set of rules as defined by updating.

The embodiments herein may be related to a single or limited number of patients. However, it should be appreciated that a plurality or a network of the patients 202 (as shown in FIGS. 1 and 2) may be included in the system 300 such that the patients 202 may include the patient 202a as discussed above referred to such as a first patient 202a. The patients 202 including the first patient 202a are allowed to create a marketplace for selling of the medical records, at least in part, or for authorizing access for limited use of the medical records, at least in part, upon being registered with the at least one central repository 302 or the server 204 through the sign in scheme 210, as discussed above.

In an example, the embodiments herein provide a computer program product configured to include a pre-configured set of instructions, which when performed, can result in actions as stated in conjunction with the method 600 or 700 described above. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here.

Embodiments within the scope of the present disclosure may also include tangible and/or non-transitory computer-readable storage media for carrying or having computer executable instructions or data structures stored thereon. Such non-transitory computer readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer executable instructions, data structures, or processor chip design. When information is transferred or provided over a network 104 or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network 104 environments. Generally, program modules include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network 104). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network 104 adapters.

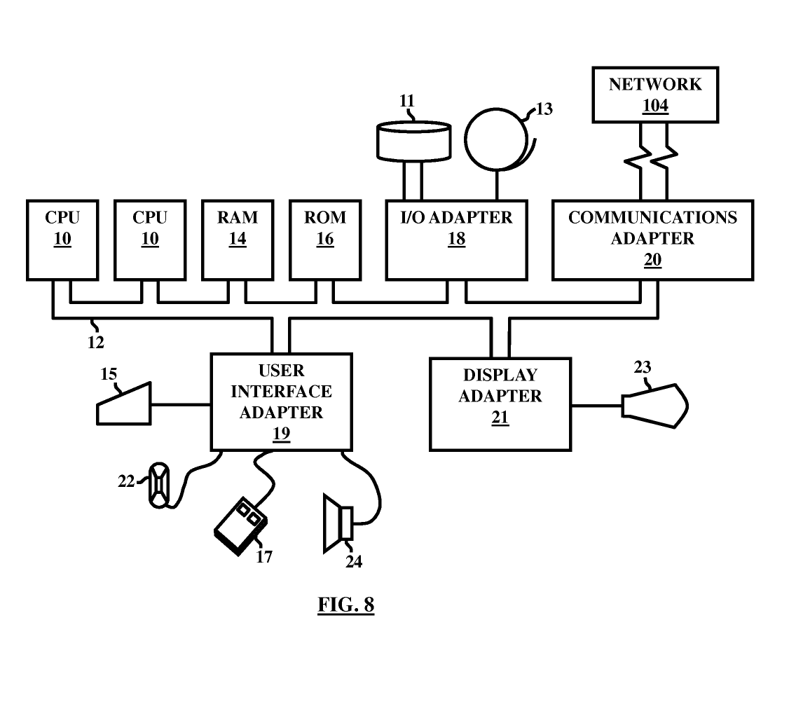

A representative hardware environment for practicing the embodiments herein is depicted in FIG. 8, with reference to FIGS. 1 through 7. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 104, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for storing and creating medical records, and authorizing access to a third party at least in part for said medical records, said system comprising: at least one server, wherein said server includes or is coupled to at least one central repository, said at least one central repository storing multiple patient files, wherein each patient file is associated with a patient and contains patient data, wherein said patient is registered with said at least one central repository using a sign in scheme and allowed to store said medical records associated with said patient after signing in through said sign in scheme;
a communication network, wherein said system is connected over the communication network, said communication network further facilitating communication between said patient and said third party; and
a device for authorizing access to said third party for said medical records at least in part, said device including:
a second repository storing a set of rules dictating access rights and levels for said third party based on information associated with said third party;
an access module that processes authorization of said third party for access of said medical records, at least in part; and
a processing component that creates said medical records, at least in part, based on said authorization by said access module.

2. The system of claim 1, wherein said medical records comprises at least one of the type of: demographic information of said patient, clinical information of said patient, lab information of said patient, and medication related information of said patient, wherein each of said type of said medical records is defined by unique identifiers in association with specific access rules and corresponding costs of access rights.

3. The system of claim 1, wherein said patient comprises a first patient, said system further comprising a network of one or more patients, wherein patients including the first patient are allowed to create a marketplace for selling of said medical records, at least in part, or for authorizing access for limited use of said medical records, at least in part, upon being registered with said at least one central repository through said sign in scheme, wherein said sign in scheme comprises a social networking platform.

4. The system of claim 1, wherein said third party comprises at least one of a pharmacy, a hospital, a government agency, a patient of the patients, a nursing center, an attorney, an insurance unit, an educational institution, and a physician.

5. The system of claim 1, further comprising an interface unit for providing an interface to said patient and said third party to respectively update said medical records of said patient and view or extract said medical records as authorized by said patient, at least in part.

6. The system of claim 1, further comprising a price calculator, wherein said price calculator executes instruction as stored in said second repository storing said set of rules to calculate a billable amount charged to said third party for gaining access rights to said medical records, at least in part.

7. The system of claim 1, wherein the information indicative of a patient interest in selling or authorizing access for said medical records, at least in part, is viewable publicly to said third party upon registration of said patient with said central repository.

8. The system of claim 1, further comprising a communication channel allowing transfer of said medical records through at least one of a wired and wireless transmission technique to a destination identified by said third party, upon successful authorization of said access by said patient and payment of a billable amount equivalent to obtain said access right of the medical records, at least in part, as specified by said patient.

9. The system of claim 1, further comprising a patient input module to receive an input manually from said patient regarding authorization access in terms of binary values and costs associated with said authorization access, wherein said set of rules being used in association with said input for providing access to said third party.

10. The system of claim 9, wherein said patient is allowed to alternatively select one of:
an automated way of access authorization for said medical records, at least in part, based on said set of rules stored in said second repository; and
a manual way of access authorization for said medical records, at least in part, based on said input received by said patient manually through said input module.

11. The system of claim 1, wherein said third party is communicatively connected to said patient through said social networking platform, said server being one of repositories maintained by a provider of social networking service through said social networking platform.

12. A system for storing and creating electronic records, and authorizing access to a consumer at least in part for said electronic records by an owner of said electronic records, said system comprising:
at least one server, wherein said server includes or is coupled to:
at least one central repository, said at least one central repository storing multiple files, wherein each file is associated with an owner and contains data specific to the owner, wherein said owner is registered with said at least one central repository using a sign in scheme and allowed to store said electronic records associated with said owner after signing in through said sign in scheme;
a communication network, wherein said system is connected over the communication network, said communication network further facilitating communication between said owner and said consumer; and
a device for authorizing access to said consumer for said electronic records at least in part, said device including:
a second repository storing a set of rules dictating access rights and levels for said consumer based on information associated with said consumer;
an access module that processes authorization of said consumer for access of said electronic records, at least in part; and
a processing component that creates said electronic records, at least in part, based on said authorization by said access module.

13. A method for storing and creating medical records, and authorizing access to a third party at least in part for said medical records, said method comprising:
receiving a registration request with a central repository through a sign in platform from a patient, wherein said sign in platform is accessed through a social networking platform;
receiving information from said patient including personal details of said patient and details related to said patient indicative at least of said medical records associated with said patient for storage within said central repository; and
defining access rules dictating access rights for said third party desiring an authorization for access of said medical records, at least in part, based on said information associated with said third party and said information received from said patient.

14. The method of claim 13, further comprising defining pricing and billing rules associated in return for a grant of said access for authorization to said third party for said medical records, at least in part based on said information received from said patient.

15. The method of claim 14, further comprising generating an authorization code in response to said grant of said authorization, said authorization code being used by said third party to at least create, export, view, and transfer said medical records, at least in part.

16. The method of claim 15, further comprising updating said set of rules periodically, and terminating said access of an already authorized access upon not meeting a new set of rules as defined by updating.

17. A non-transitory program storage device readable by a computer, and comprising a program of instructions executable by said computer to perform a method of storing and creating medical records, and authorizing access to a third party at least in part for said medical records, said method comprising:
receiving a registration request with a central repository through a sign in platform from a patient, wherein said sign in platform is accessed through a social networking platform;
receiving information from said patient including personal details of said patient and details related to said patient indicative at least of said medical records associated with said patient for storage within said central repository; and
defining access rules dictating access rights for said third party desiring an authorization for access of said medical records, at least in part, based on said information associated with said third party and said information received from said patient.

18. The program storage device of claim 17, wherein said method further comprises:
defining pricing and billing rules associated in return for a grant of said access for authorization to said third party for said medical records, at least in part based on said information received from said patient.

19. The program storage device of claim 18, wherein said method further comprises:
generating an authorization code in response to said grant of said authorization, said authorization code being used by said third party to at least create, export, view, and transfer said medical records, at least in part.

20. The program storage device of claim 17, wherein said method further comprises:
updating said set of rules periodically, and terminating said access of an already authorized access upon not meeting a new set of rules as defined by updating.
